(19) United States
(12) Patent Application Publication
(10) Pub. No.: US 2024/0010290 A1
(43) Pub. Date: Jan. 11, 2024

(54) Bicycle Element and Bicycle System

(71) Applicant: Canyon Bicycles GmbH, Koblenz (DE)

(72) Inventors: Martin Tony Häussler, Koblenz (DE); Eric Opitz, Weissenstadt (DE); Patrick Schmidt, Koblenz (DE); Philipp Klein, Koblenz (DE); Bastian Langlitz, Koblenz (DE); Philip Helfenberger, Koblenz (DE); René Birkenfeld, Freiburg (DE)

(21) Appl. No.: 18/217,669

(22) Filed: Jul. 3, 2023

(30) Foreign Application Priority Data
Jul. 5, 2022 (DE) 20 2022 103 756.6

(51) Int. Cl. B62J 11/19; B62K 3/02

(52) U.S. Cl. CPC B62J 11/19; B62K 3/02

(57) ABSTRACT

A bicycle element includes a bicycle frame element. The bicycle frame element is connected to a bicycle component. Further, the bicycle frame element has a battery terminal provided thereon for the electric connection of a battery. A cable connected to the battery terminal, the cable being arranged in the bicycle frame element and in the bicycle component. A holder element is connected to the bicycle component and/or the bicycle component includes the holder element. A connector element connected to the cable is fixed in the holder element. The connector element serves for connection to an electrical component, such as a lighting means, a mobile phone or the like. The invention further relates to a bicycle system.

### CROSS-REFERENCE TO RELATED APPLICATION

This application claims priority to German Patent Application No. 20 2022 103 756.6 filed Jul. 5, 2022, the disclosure of which is hereby incorporated by reference in its entirety.

### BACKGROUND OF THE INVENTION

### Field of the Invention

The invention relates to a bicycle element and a bicycle system.

### Description of Related Art

A bicycle element is, for example, a bicycle in its entirety or only a part of the bicycle, e.g., a bicycle frame in connection with a bicycle fork, a bicycle frame in connection with a handlebar and the like. In particular with e-bikes, pedelecs and the like, it is possible to also supply electric light with the energy stored in the accumulator. Switching the light on and off can be effected, possibly directly, via a switch on the handlebar or a remote unit. A large number of bicycles having an electric motor is shipped without lighting. If a customer wishes to mount lighting on such a bicycle and the lighting shall have no separate battery, but be connected directly to the battery of the bicycle, it is necessary to install a corresponding connection cable. Corresponding connection possibilities are typically located in the area of the battery terminal, i.e. in the area of electric contact with the battery. Corresponding connection possibilities may also be provided at the motor. It is then necessary to install a cable starting from the battery terminal to the lighting means. Generally, it is possible to do this inside the frame, however, this is rather difficult and complex.

Further, e-bikes are known having a magnetic holder means provided in the area of the handlebar stem. The holder means serves for magnetically holding a lighting means, the magnetic holder means additionally having electrical contacts. These are connected to the battery terminal via a cable installed in the frame. However, this is a very special solution which always requires the use of a corresponding suitable lighting means having a corresponding magnetic connection element. As such, the customer has no choice as to which lighting means he deems suitable.

### SUMMARY OF THE INVENTION

It is an object of the invention to provide a bicycle element and a bicycle system, which provide the possibility of a simple and individual connection of an electric component such as a lighting means.

According to the invention, the object is achieved with a bicycle element with the features as described herein and with a bicycle system with the features as described herein.

The bicycle element according to the invention comprises a bicycle frame element and a bicycle component connected to the bicycle frame element. For example, the bicycle frame element is a bicycle frame or a part of a bicycle frame, such as a top tube, a down tube and/or a head tube. The bicycle component is a component connected to the bicycle frame element, such as a handlebar stem, a handlebar, a seat post, a stay, a luggage carrier or the like. The bicycle component may also be a fastening element for other components, such as a headset, a clamp for the saddle tube or the like.

The bicycle element according to the invention further comprises a battery terminal which is preferably provided on the bicycle frame element. Such a battery terminal may be arranged, for example, inside the bicycle frame, e.g. inside a top tube, a head tube and/or a down tube. It is, in particular, possible that the battery terminal is connected to an electric motor via a power line, the motor being preferably connected to the bicycle frame element, either directly or indirectly. According to the invention, a cable is directly or indirectly connected to the battery terminal. Preferably, it is possible that the cable is connected to the power line. In a preferred embodiment, a terminal device, preferably having a terminal clamp, may be provided between the power line and the cable. It is preferred that the terminal device is arranged at the electric motor. Preferably, the cable may be connected to the terminal device in a releasable, preferably couplable, or a permanent manner. The cable is arranged in the bicycle frame element, as well as in or at the bicycle component. For example, the cable is installed inside the down tube starting from a battery terminal provided in the down tube and is then passed through the head tube into a handlebar stem or the like. Further, a holder element is provided. The holder element is connected to the bicycle component. Further, the holder element may also be the bicycle component itself. The holder element serves for receiving a connector element connected to the cable, the holder element fixing the connector element. The connector element is connected to the free end of the cable so that one end is directly or indirectly connected to the battery terminal and the other end of the cable is connected to the connector element. In a preferred embodiment, the connector element is a standardized connector element. The connector element according to the invention is arranged at the holder element and easily accessible to a user. Thus, a user can connect an electrical component to the connector element. This may be, for example, a lighting means. Accordingly, the user enjoys the advantage of being able to choose a lighting element according to his needs and preferences and to connect the same to the battery of the e-bike via a simple plug-in contact. A complex installation and connection of a cable is not required. Moreover, another electronic component, such as e.g. a mobile phone, can be connected to such a connector element for charging. It is possible, for example, to connect the corresponding connector element to a lighting means or to optionally charge a mobile phone via the connector element, in particular if no lighting is required.

A corresponding connector element may be arranged in the area of a handlebar stem, a headset or directly on the handlebar. Likewise, a corresponding connector element may be arranged, for example, at a saddle tube or in the area of a saddle tube, so as to connect, e.g., a rear light thereto. Moreover, it is suitable to arrange such a connector element for example on a luggage carrier or in the area of the luggage carrier, e.g., at a seat stay.

Preferably, the holder element is designed such that the connector element is fixed in an interlocking and/or force-fitting manner. In particular, the holder element is designed such that the connector element is fixed in a clamping manner. Moreover, it is preferred that the holder element comprises an insertion opening through which the connector element is accessible. Thus, a connector of a lighting means or the like can be connected to the wire via the insertion opening. Preferably, the insertion opening is closed with a cover, so that the intrusion of moisture is avoided when the connector element is not connected to a connector.

In a particularly preferred embodiment, the holder element is integrated in a headset of a steering bearing. Specifically, the holder element is integrated into an annular component of the headset that surrounds a steer tube of a bicycle fork. The integration of the holder element into this component of the bicycle has the advantage that a simple cable guidance is possible and the connector element is well accessible. Thereby, the user can connect different electronic components to the connector element in a simple manner.

It is particularly preferred in this context that the clamping fixation of the connector element in a part of the headset is made such that the connector element is fixed simultaneously with the fixation of the headset. This has the advantage that no additional further clamping fixation or the like is required.

For example, an annular component of a headset may have an opening in which an elastic element is arranged. This elastic element cooperates with the connector element. By fixing the headset, the elastic element is compressed and thereby fixes the connector element in a clamping manner. For example, the elastic element can have a recess or opening which is arranged similar to the connector element.

As an alternative, it is also possible, for example, that the connector element is connected to the holder element by a latching connection.

Preferably, the cable is arranged in a cable duct at least in the bicycle frame element, in particular in the down tube. In this manner, a defined position of the cable is ensured and it is further ensured that the cable is not damaged, e.g., when the battery is inserted or removed. Preferably, the cable duct extends substantially from the battery terminal to a steer tube so that the cable can then be guided out from the cable duct into the steer tube to the holder element, in particular an annular element of a headset.

The invention further relates to a bicycle system with at least one bicycle element according to the invention. In particular, the bicycle system is a bicycle. The bicycle system preferably comprises at least two bicycle elements according to the invention. If the bicycle system is embodied with a plurality of bicycle elements according to the invention, it is preferred that the battery terminals of the plurality of bicycle elements are implemented by a single, common battery terminal. Thus, it is preferably realized that the plurality of cables of the plurality of bicycle elements is connected to a single battery terminal.

### BRIEF DESCRIPTION OF THE DRAWINGS

In the following, the invention is described in more detail by means of a preferred embodiment with reference to the accompanying drawings.

In the drawings:

FIG. 1 is a schematic sectional view of the bicycle frame element,

FIG. 2 is a schematic vie of the cable with a connector element and

FIG. 3 is a schematic top plan view of a bicycle component in the form of a centering ring of a headset.

### DESCRIPTION OF THE INVENTION

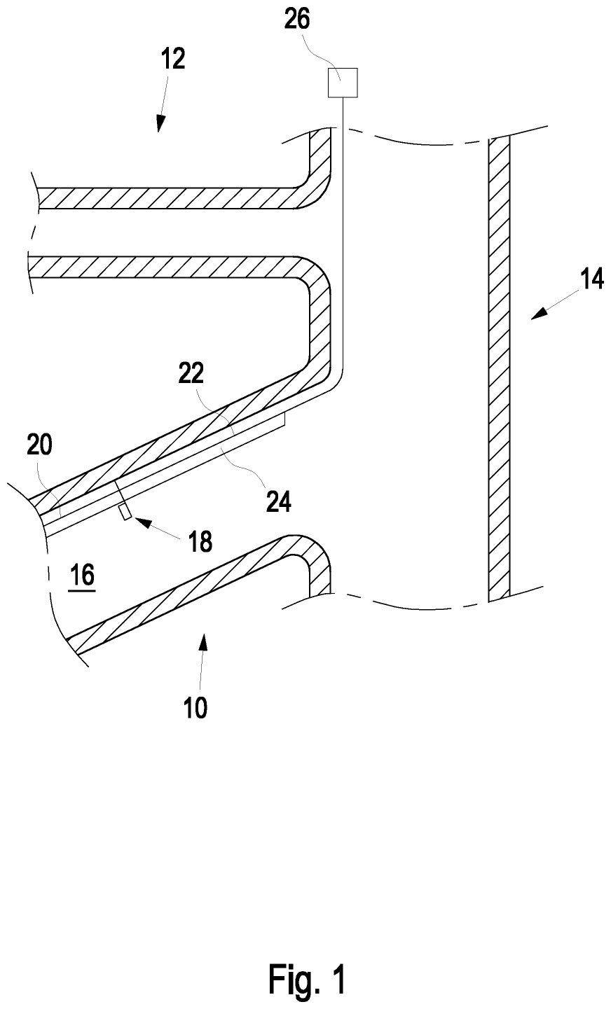

FIG. 1 schematically illustrates a bicycle frame element, showing a part of a bicycle frame which comprises a down tube 10 and a top tube 12, which are connected to each other via a steer tube 14. The battery, not illustrated, is arranged n an interior 16 of the down tube 10. The battery is inserted, for example, into the down tube from below through an opening provided in the region of the bottom bracket. Moreover, a battery terminal 18 is provided inside the down tube 10. When the battery is installed, the electric connection is established via the battery terminal 18. In the embodiment illustrated, the battery terminal 18 is connected to a cable 20 which is connected to the electric motor. Further cables, not illustrated, are connected, for example, t a control element provided on the handlebar and the like. It is essential to the invention that, in addition, a cable 22 is directly or indirectly connected to the battery terminal 18. In the embodiment illustrated, the same is arranged in a cable duct 24 and is routed towards the steer tube 14, starting from the battery terminal 18. Inside the steer tube 14, the cable 22 is routed upward toward a headset or a holder ring or the like, wherein the end of the cable 22 not connected to the battery terminal is connected to a connector element 26. As an alternative to the embodiment in FIG. 1, for example, the cable 22 can be connected to an electric motor, in particular a terminal clamp of the electric motor, with the electric motor itself being connected to the battery connector 18 via the cable 20. In this alternative embodiment, an indirect electrical connection is thus obtained between the connector element 26 and the battery terminal 18 via the cable 22 connected on the one hand to the connector element 26 and on the other hand to the electric motor, as well as via the cable 20 connected on the one hand to the electric motor and on the other hand to the battery terminal 18.

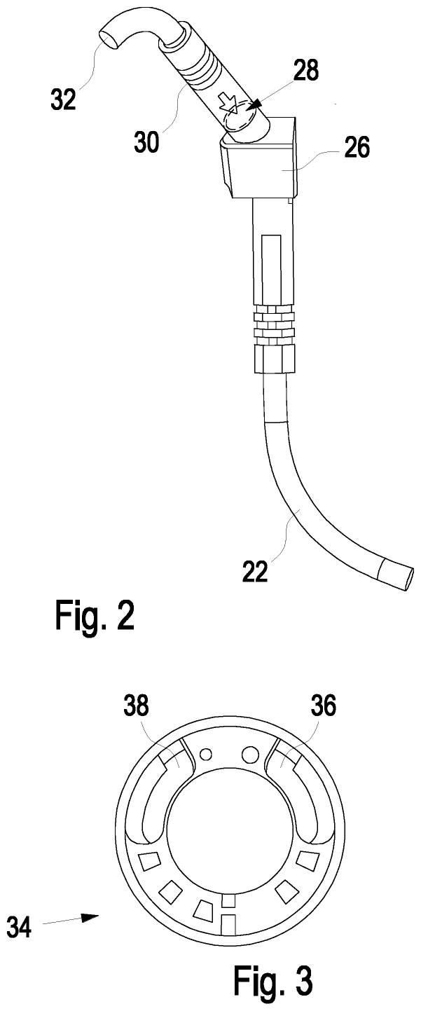

As can be seen in particular from FIG. 2, the free end of the cable 22 is connected to a connector element 26. The connector element 26 comprises an insertion opening 28. The same can be closed with a cover. The insertion opening 28 serves for insertion of a connector 30 which can then be connected, e.g., to a lighting device via a cable 32.

In a particularly preferred embodiment, the connector element 26 is arranged in a centering ring or in another component of a headset. Such a centering ring 34 (FIG. 3) has a plurality of passage openings 36, 38, for example. The passage openings 36, 38 serve for passing cables, Bowden cables, hydraulic lines and the like therethrough. In a particularly preferred embodiment, the connector element 26 is arranged in one of the openings 36, 38 or a separate opening. The connector element 26 itself is elastic or cooperates with an elastic component. The same can be compressed to fix the connector element in the holder element 34 which is embodied in particular as a centering ring. The compressing can also be effected by means of a separate element, while it is preferred that the compressing is effected by fixing the headset.

1. A bicycle element comprising
a bicycle frame element,
a bicycle component connected to the bicycle frame element,
a battery terminal preferably provided at the bicycle frame element,
a cable connected to the battery terminal, wherein the cable is arranged in the bicycle frame element in the bicycle component, and
a holder element connected to the bicycle component and/or designed as a bicycle component, which holder element fixes a connector element connected to the cable.

2. The bicycle element of claim 1, wherein the holder element fixes the connector element in a clamping manner.

3. The bicycle element of claim 1, wherein the holder element and/or the connector element comprise an insertion opening through which the connector element can be inserted into the insertion opening for electric contact with the connector element.

4. The bicycle element of claim 3, wherein the holder element is integrated in a headset of a steering bearing.

5. The bicycle element of claim 4, wherein fixing the headset causes a clamping fixation of the connector element.

6. The bicycle element of claim 5, wherein the holder element has a passage opening in which an elastically deformable clamping element is arranged which cooperates with the connector element and/or is a part of the connector element.

7. The bicycle element of claim 1, wherein at least in the bicycle frame element, in particular in a down tube, the cable is arranged in a cable duct.

8. The bicycle element of claim 7, wherein the cable duct extends at least to the steer tube, starting from the battery terminal.

9. The bicycle element of claim 1, wherein the cable is routed from the battery terminal through a bicycle frame element, in particular the down tube and/or the steer tube, into the holder element receiving the connector element.

10. A bicycle system, in particular a bicycle, comprising a plurality of bicycle elements of claim 1, wherein the battery terminals of the plurality of bicycle elements are one and the same battery terminal.

11. A bicycle system, in particular a bicycle, comprising a single bicycle element of claim 1.
